(19) United States
(12) Patent Application Publication
(10) Pub. No.: US 2026/0184255 A1
(43) Pub. Date: Jul. 2, 2026

(54) SAFETY BINDING DEVICE HAVING PROTECTION FUNCTION

(71) Applicant: Ningbo Qili Metal Products Co., LTD, Ningbo City (CN)

(72) Inventors: Ziteng Wang, Ningbo City (CN); Qingsen Huang, Ningbo City (CN); Wuling Li, Ningbo City (CN)

(21) Appl. No.: 19/431,782

(22) Filed: Dec. 23, 2025

(30) Foreign Application Priority Data
Dec. 29, 2024 (CN) 202423257092.X

(51) Int. Cl. B60P 7/08

(52) U.S. Cl. CPC B60P 7/083

(57) ABSTRACT

The present disclosure relates to a safety binding device having a protection function. The safety binding device includes a left plate and a right plate, where a bolt and a lock nut are arranged; and a left pad and a right pad are arranged between the left plate and the right plate, and clamping grooves are provided on the left pad and the right pad. Gears for retracting webbings of a product are designed to two outer or inner ends of the product, so as to retract the webbings smoothly and bind goods successfully; an outer protection cover of a spiral spring presses a protection cover by stamping protruding ports; holes on the left plate and the right plate are easy to align; the purpose of uniform retraction is achieved through an externally arranged rotating plate; and a tail end of a handle spring is of a concealed structure.

### TECHNICAL FIELD

The present disclosure relates to the technical field of goods binding, and in particular to a safety binding device having a protection function.

### BACKGROUND

A binding fixing device, an extremely important fixing tool in transportation of goods, and a binding fixator strap that is also known as a goods lashing device and is a fixing device used during transportation and movement of the goods, have locking performance, do not fall off, are safe, reliable, lightweight, and simple to operate, protect objects against damage, are suitable for diverse environments according to different hook types, and are also known as a binder, a fastener, a fastening strap, and a military binding strap.

However, an existing binding device further has the following issues during use:
1. Gears for retracting webbings used in an existing safety binding device are typically assembled into a product. With an improper assembly method during retraction, the gears often become jammed, resulting in unsmooth retraction of the webbings.
2. As a spiral spring for retraction, its outer protection cover is riveted and fixed through pins at two ends, resulting in an unfirm fixing structure and high cost.
3. An outer body of the product is used for assembling various small parts. Left sides and right sides of outer bodies of a number of products on market are integrally formed. Thus, holes are not alignable after the left sides and the right sides are bent when various parts such as pins are assembled, making assembly difficult and time-consuming.
4. A number of products on market cannot be retracted at a constant speed when the webbings are retracted. With excessively rapid retraction of the webbings, the webbings will hit hands of a consumer, posing a safety hazard.
5. A spring tail end on a handle part of the existing safety binding device product is exposed on a front surface of the product. The exposed spring tail end will harm the hands of the user when a user pulls the handle, posing a safety hazard.

Thus, it is necessary to provide a safety binding device having a protection function for use.

### SUMMARY

In order to solve the above problem, the present disclosure provides a safety binding device having a protection function. The specific technical solution is as follows:

a safety binding device having a protection function includes a left plate and a right plate, where a bolt and a lock nut are arranged at rear ends of the left plate and the right plate, and the bolt passes through the left plate and the right plate to fix the left plate and the right plate along with the lock nut; a left pad and a right pad are arranged between the left plate and the right plate, clamping grooves are provided on the left pad and the right pad, a main shaft is arranged between the left pad and the right pad, two ends of the main shaft are provided with clamping blocks clamped to the clamping grooves respectively, a rotating shaft passing through the main shaft is arranged on the main shaft, the rotating shaft passes through the left plate to extend to an outer side of the right plate, and a clamping ring clamped to the right plate is arranged on the rotating shaft; a protection cover is arranged on the right plate, a spiral spring is arranged in the protection cover, a middle position of the spiral spring is clamped on the rotating shaft, and the spiral spring is connected to the protection cover; front ends of the left plate and the right plate are provided with a left handle cover and a right handle cover respectively, and rear ends of the left handle cover and the right handle cover are provided with a connected fixing shaft; a handle is arranged between the left handle cover and the right handle cover; a left sheath and a right sheath are arranged on the left plate and the right plate respectively; two shaft cores are arranged between the left sheath and the right sheath, a gap is provided between the two shaft cores, and left sides and right sides of the shaft cores are provided with a left gear and a right gear which are inserted respectively; and end portions of the two shaft cores are provided with fixing strips for fixation respectively, and a knob is arranged on the fixing strip located at a position of the right gear.

Further, three protruding ports distributed circumferentially are provided on the right plate, and the protection cover is clamped to the three protruding ports.

Further, a safety buckle fixing block is clamped at middle positions of the left plate and the right plate, sliding grooves are provided on the left plate and the right plate respectively, a safety buckle in sliding fit is arranged between the two sliding grooves, and a safety buckle spring is arranged between the safety buckle fixing block and the safety buckle.

Further, a pin and a safety buckle pin are riveted between the left handle cover and the right handle cover.

Further, slipping grooves are provided on the left handle cover and the right handle cover, two ends of the handle are slidably connected in the two slipping grooves respectively, a handle spring is fixedly connected on the handle, and the handle spring is fixed to the right handle cover.

Further, protection pads are arranged between the left gear or the right gear and the fixing strips.

The present disclosure has the beneficial effects: 1, gears for retracting webbings of a product are designed to two outer or inner ends of the product, so as to retract the webbings smoothly and bind goods successfully.

2, an outer protection cover of the spiral spring presses the protection cover by stamping the protruding ports on the right plate, such that the protection cover is safely fixed on the product, and stable retraction of the webbings is ensured.

3, a body is the left plate and the right plate which are separate, such that assembly is rapid, and cost is low. Since the body is a separate part, holes of the left plate and the right plate are easy to align for assembly, such that an assembly qualification rate is high.

4, the knob is designed at an outer retraction end of the product. By rotationally pressing the knob, friction resistance is generated by pressing against the gears, such that the webbings are retracted at a constant speed and do not hit hands of a user, and the product is safe and firm.

5, a tail end of a handle spring is of a concealed structure. Since the tail end of the spring is concealed on a back surface of the handle, a sharp corner of the tail end of the spring can be avoided when the user pulls up or pulls down the handle. Thus, the hands of the user are not hurt, and the product is safe and firm.

### BRIEF DESCRIPTION OF THE DRAWINGS

FIG. 1 is a first schematic diagram of an overall structure of the present disclosure.

FIG. 2 is a second schematic diagram of an overall structure of the present disclosure.

FIG. 3 is a split diagram of a three-dimensional of the present disclosure.

FIG. 4 is a schematic diagram of a protruding port on a right plate of the present disclosure.

FIG. 5 is a schematic diagram in which gears are designed at two inner ends of a product of the present disclosure.

Reference numerals: left plate 1, right plate 2, bolt 3, lock nut 4, left pad 5, right pad 6, main shaft 7, rotating shaft 8, protection cover 9, spiral spring 10, left handle cover 11, right handle cover 12, fixing shaft 13, handle 14, left sheath 15, right sheath 16, shaft core 17, fixing strip 18, protruding port 19, safety buckle fixing block 20, safety buckle 21, safety buckle spring 22, pin 23, handle spring 24, protection pad 25, clamping groove 26, clamping block 27, sliding groove 28, slipping groove 29, left gear 30, right gear 31, clamping ring 32, safety buckle pin 33, and knob 34.

### DETAILED DESCRIPTIONS OF THE EMBODIMENTS

The implementation of the present disclosure will be further described in detail below in combination with the accompanying drawings and the embodiments. The following detailed description of the embodiments and the accompanying drawings serve to illustrate principles of the present disclosure illustratively, but are not intended to limit the scope of the present disclosure. The present disclosure can be implemented in various different forms, is not limited to the particular embodiments disclosed herein, but includes all the technical solutions falling within the scope of the claims.

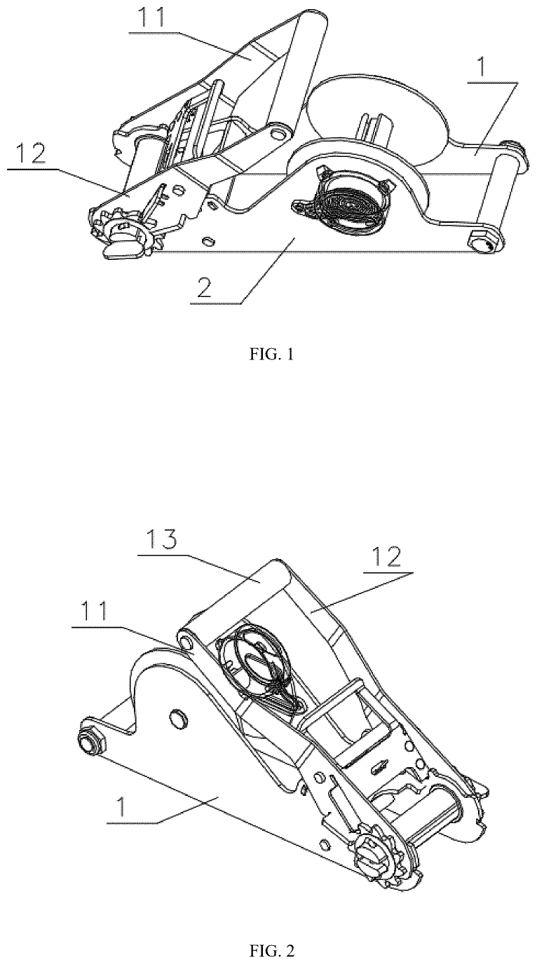

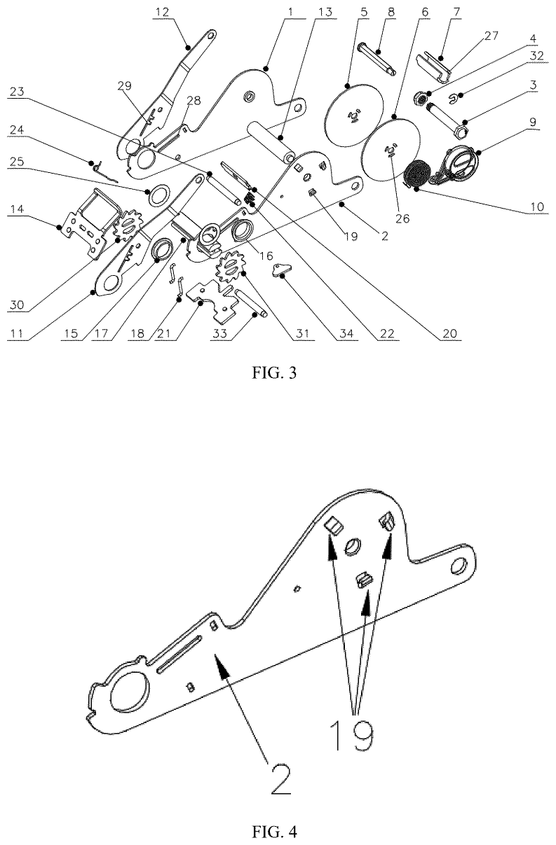

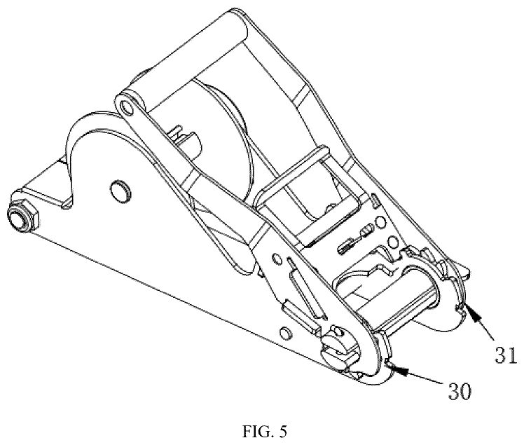

With reference to FIG. 1-FIG. 5, a design of a safety binding device having a protection function is provided in an embodiment. The safety binding device includes a left plate 1 and a right plate 2. A bolt 3 and a lock nut 4 are arranged at rear ends of the left plate 1 and the right plate 2, and the bolt 3 passes through the left plate 1 the right plate 2 to fix the left plate 1 and the right plate 2 along with the lock nut 4. A left pad 5 and a right pad 6 are arranged between the left plate 1 and the right plate 2, clamping grooves 26 are provided on the left pad 5 and the right pad 6, a main shaft 7 is arranged between the left pad 5 and the right pad 6, two ends of the main shaft 7 are provided with clamping blocks 27 clamped to the clamping grooves 26 respectively, a rotating shaft 8 passing through the main shaft is arranged on the main shaft 7, the rotating shaft 8 passes through the left plate 1 to extend to an outer side of the right plate 2, and a clamping ring 32 clamped to the right plate 2 is arranged on the rotating shaft 8. A protection cover 9 is arranged on the right plate 2, a spiral spring 10 is arranged in the protection cover 9, a middle position of the spiral spring 10 is clamped on the rotating shaft 8, and the spring 10 is connected to the protection cover 9. Front ends of the left plate 1 and the right plate 2 are provided with a left handle cover 11 and a right handle cover 12 respectively, and rear ends of the left handle cover 11 and the right handle cover 12 are provided with a connected fixing shaft 13. A handle 14 is arranged between the left handle cover 11 and the right handle cover 12. A left sheath 15 and a right sheath 16 are arranged on the left plate 1 and the right plate 2 respectively. Two shaft cores 17 are arranged between the left sheath 15 and the right sheath 16, a gap is provided between the two shaft cores 17, and left sides and right sides of the shaft cores 17 are provided with a left gear 30 and a right gear 31 which are inserted respectively. End portions of the two shaft cores 17 are provided with fixing strips 18 for fixation respectively, and a knob 34 is arranged on the fixing strip 18 located at a position of the right gear 31.

In the present disclosure, gears for retracting webbings of a product are designed to two outer or inner ends of the product. As shown in FIG. 2 and FIG. 5, a schematic diagram in which the gears are designed at two outer or inner ends is provided in the embodiment, so as to retract the webbings smoothly and bind goods successfully. An outer protection cover of the spiral spring presses the protection cover by stamping the protruding ports on the right plate, such that the protection cover is safely fixed on the product, and stable retraction of the webbings is ensured. A body is the left plate and the right plate which are separate, such that assembly is rapid, and cost is low. Since the body is a separate part, holes of the left plate and the right plate are easy to align for assembly, such that an assembly qualification rate is high. The knob is designed at an outer retraction end of the product. By rotationally pressing the knob, friction resistance is generated by pressing against the gears, such that the webbings are retracted at a constant speed and do not hit hands of a user, and the product is safe and firm. A tail end of a handle spring is of a concealed structure. Since the tail end of the spring is concealed on a back surface of the handle, a sharp corner of the tail end of the spring can be avoided when the user pulls up or pulls down the handle. Thus, the hands of the user are not hurt, and the product is safe and firm.

Preferably, three protruding ports 19 distributed circumferentially are provided on the right plate 2, and the protection cover 9 is clamped to the three protruding ports 19.

Preferably, a safety buckle fixing block 20 is clamped at middle positions of the left plate 1 and the right plate 2, sliding grooves 28 are provided on the left plate 1 and the right plate 2 respectively, a safety buckle 21 in sliding fit is arranged between the two sliding grooves 28, and a safety buckle spring 22 is arranged between the safety buckle fixing block 20 and the safety buckle 21.

Preferably, a pin 23 and a safety buckle pin 33 are riveted between the left handle cover 11 and the right handle cover 12.

Preferably, slipping grooves 29 are provided on the left handle cover 11 and the right handle cover 12, two ends of the handle 14 are slidably connected in the two slipping grooves 29 respectively, a handle spring 24 is fixedly connected on the handle 14, and the handle spring 24 is fixed to the right handle cover 12. The slipping grooves 29 provide sliding limit for the handle 14 during movement.

Preferably, protection pads 25 are arranged between the left gear 30 or the right gear 31 and the fixing strips 18. Gaps are generated between the left gear 30 or the right gear 31 and the fixing strips 18 through the protection pads 25.

It should be noted that in the safety binding device, webbings are connected between the two shaft cores 17 and on the main shaft 7 respectively.

An assembly mode in the present disclosure is as follows:
assembly steps include:
step 1, a spiral spring 10 is assembled into a protection cover 9, and fixed on a right plate 2 through a protrusion and a rivet pin on the right plate 2, and a bolt 3 is fixed on the right plate 2 through a lock nut 4;
step 2, a rotating shaft 8 is assembled on a main shaft 7, and then conveniently fixed on the right plate 2 and a left plate 1 through a clamping ring;
step 3, a right sheath 16 and a left sheath 15 are mounted on a right gear 31 and a left gear 30, and then are conveniently fixed on the right plate 2 and the left plate 1 through fixing strips 18;
step 4, one end of a handle spring 24 is fixed on a right handle cover 12, and the other end of the handle spring is fixed on a handle 14;
step 5, a safety buckle spring 22 is assembled to a safety buckle 21, and then two ends of the safety buckle spring are fixed on the right plate 2 and the left plate 1 respectively;
step 6, two ends of a pin 23 are riveted and fixed on the right plate 2 and the left plate 1 respectively; and
step 7, two ends of a fixing shaft 13 are riveted and fixed on the right handle cover 12 and a left handle cover 11 respectively, and then a combined body is fixed on the right plate 2 and the left plate 1.

An operation mode in the present disclosure is as follows:
step 1, one webbing is pulled out and fixed on goods, and the other webbing is fixed on the other end of the goods, so as to bind the goods;
step 2, the webbings may be tightened through a pulling force of a fixing shaft 13; and
step 3, the webbings may be retracted through an elastic force of a spiral spring 10.

The technical principles of the present disclosure are described above in combination with particular embodiments. These descriptions are intended only to explain the principles of the present disclosure and should not be construed in any way as limiting the scope of the present disclosure. Based on the explanation herein, those skilled in the art can conceive of other specific implementations of the present disclosure without making creative efforts, and these implementations fall within the scope of protection of the claims of the present disclosure.

What is claimed is:

1. A safety binding device having a protection function, comprising: a left plate and a right plate, wherein a bolt and a lock nut are arranged at rear ends of the left plate and the right plate, and the bolt passes through the left plate and the right plate to fix the left plate and the right plate along with the lock nut;
a left pad and a right pad are arranged between the left plate and the right plate, clamping grooves are provided on the left pad and the right pad, a main shaft is arranged between the left pad and the right pad, two ends of the main shaft are provided with clamping blocks clamped to the clamping grooves respectively, a rotating shaft passing through the main shaft is arranged on the main shaft, the rotating shaft passes through the left plate to extend to an outer side of the right plate, and a clamping ring clamped to the right plate is arranged on the rotating shaft;
a protection cover is arranged on the right plate, a spiral spring is arranged in the protection cover, a middle position of the spiral spring is clamped on the rotating shaft, and the spiral spring is connected to the protection cover;
front ends of the left plate and the right plate are provided with a left handle cover and a right handle cover respectively, and rear ends of the left handle cover and the right handle cover are provided with a connected fixing shaft; a handle is arranged between the left handle cover and the right handle cover;
a left sheath and a right sheath are arranged on the left plate and the right plate respectively; two shaft cores are arranged between the left sheath and the right sheath, a gap is provided between the two shaft cores, and left sides and right sides of the shaft cores are provided with a left gear and a right gear which are inserted respectively; and
end portions of the two shaft cores are provided with fixing strips for fixation respectively, and a knob is arranged on the fixing strip located at a position of the right gear.

2. The safety binding device having a protection function according to claim 1, wherein three protruding ports distributed circumferentially are provided on the right plate, and the protection cover is clamped to the three protruding ports.

3. The safety binding device having a protection function according to claim 2, wherein a safety buckle fixing block is clamped at middle positions of the left plate and the right plate, sliding grooves are provided on the left plate and the right plate respectively, a safety buckle in sliding fit is arranged between the two sliding grooves, and a safety buckle spring is arranged between the safety buckle fixing block and the safety buckle.

4. The safety binding device having a protection function according to claim 1, wherein a pin and a safety buckle pin are riveted between the left handle cover and the right handle cover.

5. The safety binding device having a protection function according to claim 1, wherein slipping grooves are provided on the left handle cover and the right handle cover, two ends of the handle are slidably connected in the two slipping grooves respectively, a handle spring is fixedly connected on the handle, and the handle spring is fixed to the right handle cover.

6. The safety binding device having a protection function according to claim 1, wherein protection pads are arranged between the left gear or the right gear and the fixing strips.
